(19) United States
(12) Patent Application Publication
(10) Pub. No.: US 2003/0011846 A1
(43) Pub. Date: Jan. 16, 2003

(54) Method and apparatus for network link planning

(76) Inventors: Masoud Gholamhosseini, Ottawa (CA); Allen Jacob Braun, Kanata (CA)

Correspondence Address: G. Ronald Bell & Associates, Patent & Trade-Mark Agents, P.O. Box 2450, Postal Station "D", Ottawa, ON, K1P 5W6, CA

(21) Appl. No.: 10/146,957

(22) Filed: May 17, 2002

Related U.S. Application Data
(60) Provisional application No. 60/304,077, filed on Jul. 11, 2001.
(60) Provisional application No. 60/354,932, filed on Feb. 11, 2002.

(51) Int. Cl. H04J 14/08

(52) U.S. Cl. 359/135

(57) ABSTRACT

The present invention provides a method and apparatus to facilitate optimum use of network components. Using an intelligent engine, or link planning tool, network components are placed on links in a simulated network while keeping the amount of consumed power within a desired range. Based on provided customer network data, a minimum number of cards necessary to make the requested network is allocated. The simulated network includes card and shelf allocations, wiring, and slot assignment within shelves. An export database and at least one report are generated following execution of steps in the method. Examples of such a report are: shelf card inventory report; shelf card and fiber wiring report; equipment list; lightpath trace report; and simulation report. Each report is output in a format suitable for end-user use and consideration. The present invention can be applied to networks having different topologies, e.g. mesh networks, ring networks, or point-to-point networks.

### FIELD OF THE INVENTION

The present invention relates generally to the areas of optical network planning and modeling, and more specifically to the areas of link planning and network component allocation in optical networks.

### BACKGROUND OF THE INVENTION

Optical communications networks have become a preferred technology for data communication. Optical networks provide high data transmission capacity with low-loss transmission over a large frequency range. Consequently, data signals can be transmitted at high speeds and over large distances before amplification or regeneration is needed, thus providing advantages over traditional electronic networks.

As with any other type of network, the arrangement of components within an optical network should be considered. For instance, as a consequence of large number of nodes and link loss in the optical layer, a link on an optical network might fail. At the time of such a link failure, the network response thereto will depend on the type and amount of network planning that had occurred before deployment of the optical network, including decisions regarding the placement of network components. Typically, issues relating to where optical and electrical network components should be placed within a network are considered by a network planner based on knowledge of the potential interaction of the various network components. This dependence on the network planner's knowledge relating to the arrangement of network components opens up possible areas of network vulnerability.

Aside from issues relating to link failure, the placement or arrangement of network components in different manners may affect whether the various components are being used in an optimal manner with respect to one or more criteria, taking advantage of all of their respective features. Furthermore, there are many possible criteria by which optimal use and arrangement of network components may be measured, such as cost, power consumption, etc. If network components are not placed in an optimal manner with respect to desired criteria, the network could be operating inefficiently, or could be vulnerable in the case of certain network conditions, or both. The manual consideration by a network planner of each of these issues on an individual or collective basis may become quite tedious, may involve a large number of calculations and scenarios, and may not consider all of the relevant issues. However, there has thus far been no alternative to the manual consideration of such issues relating to network component arrangement and use.

Therefore, there is a need in industry for an improved system and method for network planning and network component arrangement.

### SUMMARY OF THE INVENTION

The present invention seeks to provide an improved network planning and network component arrangement process that overcomes or mitigates at least one of the drawbacks of the conventional processes.

The present invention provides a novel method and apparatus to ensure optimum use of network components. Embodiments of the present invention preferably use an intelligent engine, or link planning tool, to place network components on the links in a network to keep the amount of consumed power within a desired range.

According to an aspect of the present invention, there is provided a computer-implemented method for network link planning comprising the steps of: a) obtaining data relating to a simulated optical network; b) allocating and virtually wiring network components including one or more network cards, channel filter cards, band filter cards and shelves in the network based on said obtained data; c) assigning slots for all cards in the network; and d) generating at least one report based on said allocations, assignments and virtual wirings in the network.

Preferably, the network components include one or more interchange cards and amplifiers, and optionally include one or more channel (OSC) filter cards, dispersion compensation module (DCM) cards, control cards and electrical cards. One or more of such cards may constitute set cards. The data that is obtained in step a) may be one or more of the following data types: equipment name data; rules data; component characteristics data; fiber topology data; node topology data; user card data; lightpath topology data; broadband amplifier location data; and OSC location data. Such obtained data is advantageously formatted as a network object model having a network object component model for each network component in the simulated network. In such a case, step a) may advantageously include the step populating the network object model from a pre-existing network object model.

The allocation and virtual wiring of set cards in step b) may preferably comprise the steps of: a8) allocating at least one lightpath to fill any band having at least one lightpath not fulfilled; b8) allocating an add channel filter card for any lightpath without its add channel filter card allocated and virtually wiring said add channel filter card into the network; c8) allocating a drop channel filter card for any lightpath not having its drop channel filter card allocated and virtually wiring said drop channel filter card into the network; d8) allocating an add band filter card for any lightpath without its add band filter card allocated and virtually wiring said add band filter card into the network; e8) allocating a drop band filter card for any lightpath not having its drop band filter card allocated and virtually wiring said drop band filter card into the network; and f8) allocating a network card for any lightpath not having its network card allocated and virtually wiring said network card into the network. In such a case, step a8) may preferably comprise the step of marking said at least one allocated lightpath for future deletion.

The allocation and virtual wiring of interchange cards in step b) may preferably comprise the steps of: a10) determining a group of input and output fibers having the most bands in common with each other and virtually wiring up a pass-through between said input and output fibers through a network node; and b10) adding a set of band filters to interchange lightpaths between said input and output fibers for any node at which said input and output fibers are not virtually wired together. Step b10) may advantageously comprise the steps of: for each of M input fibers, storing a number of bands in common with each of N output fibers; while at least one input fiber having no pass-through fiber assigned has a non-zero number of bands in common with an output fiber, performing the following steps a11-c11: a11) determining an input fiber X with the greatest number of bands in common with an output fiber Y; b11) designating X as a pass-through to Y; c11) finding and removing all references in the input fibers to Y; and for each input fiber, allocating at least one interchange card for each band that is not dropped or that is not on the pass-through. This portion of the method may also advantageously comprise the step of adding, at specified locations, one or more network components selected from the group comprising: broadband amplifiers, OSC filter cards, and DCM cards.

The allocation and virtual wiring of interchange cards in step b) may further comprise the step of re-ordering cards in the network so as to distribute a link margin, thereby reducing the need for amplifiers. The step of reordering said cards in the network may advantageously comprise the steps of: observing an available margin for the lowest margin lightpath at each filter; and swapping filters where the positive margin available in one filter is sufficient to convert a negative margin filter to a positive margin filter. The step of reordering said cards in the network may also comprise the step of determining whether there is an ordering between remaining filters that will distribute any available margin so as to reduce a need for large, expensive amplifiers in favor of simpler, less expensive amplifiers. The step of reordering said cards in the network may comprise the step of determining which wavelengths are lit up on fiber and components of the network. Finally, the step of reordering said cards in the network may comprise the step of calculating and storing the power and standard deviation of a plurality of lightpaths at a plurality of points in the network, which is preferably performed for every lightpath at every point in the network.

When an incremental set of lightpaths is needed, the allocation and virtual wiring of amplifiers in step b) may preferably comprise the step of virtually wiring existing network components so that such virtual wiring can only be broken at designated points. In an iteration through all the lightpaths, the allocation and wiring of amplifiers in step b) may advantageously comprise the step of, for each lightpath, adding a set amount to a global margin when amplifiers have been added or removed; preferably, each lightpath is examined in sequence in such iteration.

The allocation and virtual wiring of amplifiers in step b) may preferably comprise the steps of: calculating possible power ranges at every card port passed through by a particular lightpath; and adding a drop amplifier if the following conditions are satisfied: a22) one or more of said power ranges falls below an acceptable lower bound at any port where such lower bound is specified; b22) a drop amplifier does not already exist in the lightpath; and c22) an input power range at a proposed drop amplifier location is between a minimum input bound and a maximum input bound. Alternatively, the condition c22) may be replaced by the condition: c24) an input power range at a proposed drop amplifier location is above a maximum input bound and at least one electrical variable optical attenuator is adjusted so as to render the power range to an acceptable level. The step of calculating possible power ranges may advantageously be performed using a statistical deviation method and extra global margin currently available.

The allocation and virtual wiring of amplifiers in step b) may advantageously comprise the steps of: calculating possible power ranges at every card port passed through by a particular lightpath; and adding an add amplifier if the following conditions are satisfied:

a25) one or more of said power ranges falls below an acceptable lower bound at any port where such lower bound is specified; b25) an add amplifier does not already exist in the lightpath; and c25) the addition of an add amplifier would not saturate a receiver. This method may preferably further comprise the step of removing any inline amplifier that is saturated.

The allocation and virtual wiring of amplifiers in step b) may also advantageously comprise the steps of: calculating possible power ranges at every card port passed through by a particular lightpath; determining a location in the lightpath where the power range was last within an inline amplifier's input bounds when at least one of said power ranges falls below an acceptable lower bound at any port where such lower bound is specified; determining that a legitimate inline amplifier insertion point exists; removing any amplifier downstream from said insertion point; and adding an inline amplifier at said insertion point. If a legitimate inline amplifier insertion point is not initially found, at least one upstream electrical variable optical attenuator may advantageously be adjusted so as to create such legitimate inline amplifier insertion point. An inline amplifier's input bounds may include global margin. The steps in this paragraph may preferably be performed if one or more of said power ranges falls below an acceptable lower bound at any port where such lower bound is specified, and if one of the following conditions is satisfied: an add amplifier already exists in the lightpath; or addition of an add amplifier would saturate the receiver.

The report that is generated in step d) may preferably be one of the following types of reports: generated network database; shelf card inventory report; equipment list; shelf card and fiber wiring report; lightpath trace report; and simulation report. The simulated optical network may preferably be a mesh network, or a variant thereof, and may alternatively comprise at least one electronic network component.

According to a further aspect of the present invention, there is provided a computer program product comprising a computer-readable memory storing statements and instructions for use in the execution in a computer of a method according to an embodiment of the present invention.

According to a yet further aspect of the present invention, there is provided a computer data signal embodied in a carrier wave and representing sequences of instructions which, when executed by a processor, cause the processor to calculate network costs in an automated manner by performing the steps of a method according to an embodiment of the present invention.

According to another aspect of the present invention, there is provided a system for network link planning comprising: means for obtaining data relating to a simulated optical network; means for allocating and virtually wiring network components including one or more network cards, channel filter cards, band filter cards and shelves in the network based on said obtained data; means for assigning slots for all cards in the network; and means for generating at least one report based on said allocations, assignments and virtual wirings in the network.

According to a further aspect of the present invention, there is provided a computerized system for network link planning comprising: means for obtaining data relating to a simulated optical network; means for allocating and virtually wiring network components including one or more network cards, channel filter cards, band filter cards and shelves in the network based on said obtained data; means for assigning slots for all cards in the network; and means for generating at least one report based on said allocations, assignments and virtual wirings in the network.

The means for allocating and virtually wiring said network components is preferably adapted to allocate and virtually wire one or more network components selected from the group comprising: interchange cards; amplifiers; optical service channel (OSC) filter cards; dispersion compensation module (DCM) cards; control cards; and electrical cards. The obtained data are is preferably selected from the group comprising: equipment name data; rules data; component characteristics data; fiber topology data; node topology data; user card data; lightpath topology data; broadband amplifier location data; and OSC location data. Such obtained data advantageously comprises a network object model having a network object component model for each network component in the simulated network. In such a case, the means for obtaining data relating to a simulated optical network preferably further comprises: means for importing a pre-existing network object model; and means for populating said network object model from said pre-existing network object model.

One or more of the cards allocated and virtually wired by the means for allocating and virtually wiring said network components may be defined as set cards. The system defined above may preferably further comprise means for allocating and virtually wiring such set cards, said means for allocating and virtually wiring such set cards being adapted to perform the following steps: a41) allocating at least one lightpath to fill any band having at least one lightpath not fulfilled; b41) allocating an add channel filter card for any lightpath without its add channel filter card allocated and virtually wiring said add channel filter card into the network; c41) allocating a drop channel filter card for any lightpath not having its drop channel filter card allocated and virtually wiring said drop channel filter card into the network; d41) allocating an add band filter card for any lightpath without its add band filter card allocated and virtually wiring said add band filter card into the network; e41) allocating a drop band filter card for any lightpath not having its drop band filter card allocated and virtually wiring said drop band filter card into the network; and f41) allocating a network card for any lightpath not having its network card allocated and virtually wiring said network card into the network. In such a case, the means for allocating and virtually wiring such set cards is further adapted to perform the step of marking said at least one allocated lightpath for future deletion.

The means adapted for allocation and virtual wiring of interchange cards may preferably be further adapted to perform the following steps: a43) determining a group of input and output fibers having the most bands in common with each other and virtually wiring up a pass-through between said input and output fibers through a network node; and b43) adding a set of band filters to interchange lightpaths between said input and output fibers for any node at which said input and output fibers are not virtually wired together. In such a case, the means adapted for allocation and virtual wiring of interchange cards may advantageously be further adapted to perform the following steps as part of step b43): for each of M input fibers, storing a number of bands in common with each of N output fibers; while at least one input fiber having no pass-through fiber assigned has a non-zero number of bands in common with an output fiber, performing the following steps a44-c44: a44) determining an input fiber X with the greatest number of bands in common with an output fiber Y; b44) designating X as a pass-through to Y; c44) finding and removing all references in the input fibers to Y; and for each input fiber, allocating at least one interchange card for each band that is not dropped or that is not on the pass-through. The system may also advantageously further comprise means for adding, at specified locations, one or more network components selected from the group comprising: broadband amplifiers, OSC filter cards, and DCM cards.

The system may preferably further comprise means for re-ordering cards in the network so as to distribute a link margin, thereby reducing the need for amplifiers. The means for reordering said cards in the network may further comprise: means for observing an available margin for the lowest margin lightpath at each filter; and means for swapping filters where the positive margin available in one filter is sufficient to convert a negative margin filter to a positive margin filter. The means for reordering said cards in the network may also further comprise: means for determining whether there is an ordering between remaining filters that will distribute any available margin so as to reduce a need for large, expensive amplifiers in favor of simpler, less expensive amplifiers. The means for reordering said cards in the network may still further comprise means for determining which wavelengths are lit up on fiber and components of the network. Finally, the means for reordering said cards in the network may further comprise means for calculating and storing the power and standard deviation of a plurality of lightpaths at a plurality of points in the network, and such means may preferably calculate and store the power and standard deviation of every lightpath at every point in the network.

When an incremental set of lightpaths is needed, the means adapted for allocation and virtual wiring of amplifiers may preferably be further adapted to perform the step of virtually wiring existing network components so that such virtual wiring can only be broken at designated points. In an iteration through all the lightpaths, the means adapted for allocation and virtual wiring of amplifiers may further be advantageously adapted to perform the step of, for each lightpath, adding a set amount to a global margin when amplifiers have been added or removed; preferably, each lightpath is examined in sequence in such iteration.

The means adapted for allocation and virtual wiring of amplifiers may preferably be further adapted to perform the steps of: calculating possible power ranges at every card port passed through by a particular lightpath; and adding a drop amplifier if the following conditions are satisfied: a55) one or more of said power ranges falls below an acceptable lower bound at any port where such lower bound is specified; b55) a drop amplifier does not already exist in the lightpath; and c55) an input power range at a proposed drop amplifier location is between a minimum input bound and a maximum input bound. Alternatively, condition c55) may be replaced by the condition: c57) an input power range at a proposed drop amplifier location is above a maximum input bound and at least one electrical variable optical attenuator is adjusted so as to render the power range to an acceptable level. The means adapted for allocation and virtual wiring of said amplifiers may further advantageously be adapted for calculating possible power ranges based on a statistical deviation method and extra global margin currently available.

The means adapted for allocation and virtual wiring of amplifiers may be further advantageously adapted to perform the steps of: calculating possible power ranges at every card port passed through by a particular lightpath; and adding an add amplifier if the following conditions are satisfied: a58) one or more of said power ranges falls below an acceptable lower bound at any port where such lower bound is specified; b58) an add amplifier does not already exist in the lightpath; and c58) the addition of an add amplifier would not saturate a receiver. Such means may also advantageously further comprise means for removing any inline amplifier that is saturated.

The means adapted for allocation and virtual wiring of amplifiers may further advantageously be adapted to perform the steps of: calculating possible power ranges at every card port passed through by a particular lightpath; determining a location in the lightpath where the power range was last within an inline amplifier's input bounds when at least one of said power ranges falls below an acceptable lower bound at any port where such lower bound is specified; determining that a legitimate inline amplifier insertion point exists; removing any amplifier downstream from said insertion point; and adding an inline amplifier at said insertion point. Such means may be advantageously further adapted to adjust at least one upstream electrical variable optical attenuator if a legitimate inline amplifier insertion point is not initially found, so as to create such legitimate inline amplifier insertion point. The inline amplifier's input bounds may include global margin. Such means may also preferably be adapted means adapted to perform the steps in this paragraph if one or more of said power ranges falls below an acceptable lower bound at any port where such lower bound is specified, and if one of the following conditions is satisfied: an add amplifier already exists in the lightpath; or addition of an add amplifier would saturate the receiver.

The report that is generated by the means for generating at least one report based on allocations, assignments and virtual wirings in the network may preferably be one of the following types of reports: generated network database; shelf card inventory report; equipment list; shelf card and fiber wiring report; lightpath trace report; and simulation report. The simulated optical network may preferably be a mesh network, or a variant thereof, and may alternatively comprise at least one electronic network component.

Based on provided customer network data, a system according to an embodiment of the present invention advantageously allocates the minimum number of cards necessary to make the requested network based on user specified preferences. For instance, a user may specify a preference that increases the number of needed cards but also increases flexibility for future expansion. The system is responsible for all card and shelf allocations, all wiring, and slot assignment within the shelves.

Embodiments of the present invention can be applied to networks having different topologies, e.g. mesh networks, ring networks, or point-to-point networks. A mesh network is a topology in which devices are connected with many redundant interconnections between network nodes. In a true mesh topology every node has a connection to every other node in the network. Embodiments of the present invention are advantageously applied to mesh networks of all forms. Since ring networks, point-to-point networks, and even linear networks may be considered special cases, or subsets, of mesh network topology, embodiments of the present invention may advantageously be applied to each of these topologies.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Embodiments of the present invention will be further described with reference to the accompanying drawings, in which:

FIG. 1A illustrates a conventional node within input and output fibers;

FIG. 1B illustrates a possible distribution of wavelengths in the node of FIG. 1A;

FIG. 1C illustrates an example of band filters in an interchange card;

FIG. 2 illustrates a flowchart indicating a high-level overview of steps in a method according to an embodiment of the present invention;

FIG. 3 illustrates a flowchart indicating steps relating to data file input in the method of FIG. 2;

FIG. 4 illustrates a flowchart indicating steps relating to set card allocation in the method of FIG. 2;

FIG. 5A illustrates a flowchart indicating steps relating to interchange card allocation in the method of FIG. 2;

FIG. 5B illustrates a flowchart indicating steps in a method of assigning pass through connections within the node of FIG. 1 A according to an embodiment of the present invention;

FIG. 6 illustrates a flowchart indicating steps relating to amplifier allocation and placement in the method of FIG. 2;

FIG. 7 illustrates a flowchart indicating steps relating to drop amplifier allocation in the method of FIG. 2;

FIG. 8 illustrates a flowchart indicating steps relating to add amplifier allocation in the method of FIG. 2;

FIG. 9 illustrates a flowchart indicating steps relating to inline amplifier allocation in the method of FIG. 2;

FIG. 10 illustrates a flowchart indicating steps relating to report generation in the method of FIG. 2;

FIGS. 11A-11D illustrate examples of outputs or reports generated in accordance with embodiments of the present invention.

### DETAILED DESCRIPTION OF THE INVENTION

In the following description, the term lightpath as used herein will represent a circuit switched connection between two nodes in a network, which is set up by assigning a dedicated wavelength to it on each link in its path. A lightpath may be considered to be an optical channel. The term lightpath routing as used herein will represent the situation wherein an optical signal is routed through nodes without optical/electrical (O/E) conversion.

Before proceeding to a discussion of embodiments of the present invention, it is advantageous to discuss some background information, which will shed light on the subsequent discussion of such embodiments.

In an optical node, there are two types of network cards that provide re-routing of optical signals within the node: add-drop cards, which provide adding or dropping of signals; and interchange cards, which provide re-routing of signals between different fibers. Physically, these cards may be the same as each other, with the application being changed on each one. In different applications, the cards use the exact same hardware, firmware and software and perform the same physical function. However, the location in which they are used in the network decides the logical function that they will perform. For instance, using a band filter, if a band is dropped from the rest, then the dropped band is routed to a channel filter, a band drop logical function is being performed. On the other hand, using the same band filter, if a band is dropped from the rest, then the dropped band is routed (wired) to an add band filter, then an interchange logical function is being performed. The usage of add-drop cards at each node at the ends of the lightpath is dictated by system requirements, while the number of interchange cards needed at each node depends on the arrangement of the pass through connections between input and the output fibers and can be reduced if the number of wavelength signals diverted at each node can be reduced. A preferred embodiment of the present invention relates to a method of assigning pass-through connections within an optical node as will be described in detail later.

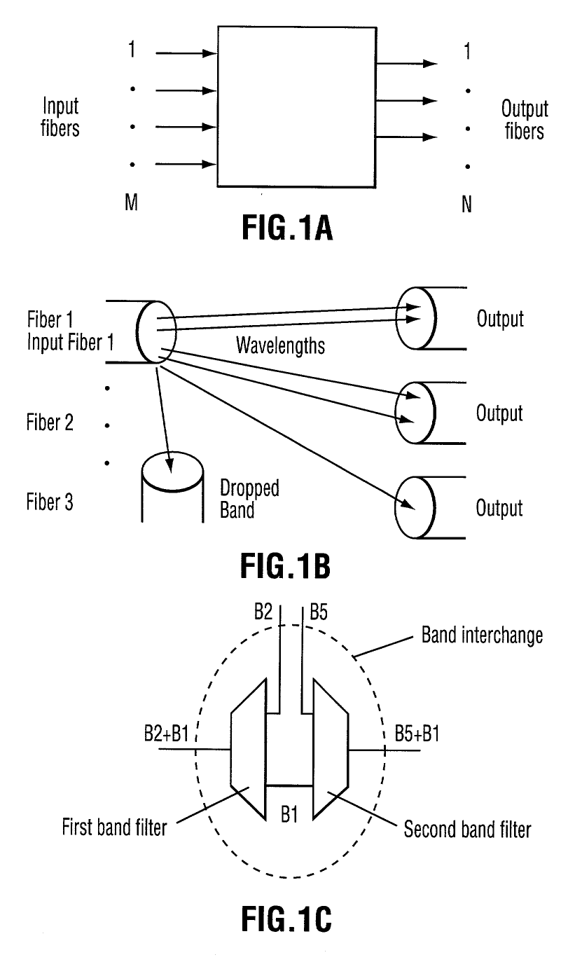

FIG. 1A illustrates a conventional node with M input fibers and N output fibers. Each of the M input fibers carry some number of wavelengths, and each incoming wavelength will be either dropped or sent to one of the N output fibers.

FIG. 1B illustrates a possible distribution of wavelengths in the node of FIG. 1A. Wavelengths that either originate (add) or terminate (drop) at this node generally have a dedicated card that cannot be removed. Such dedicated cards are of little interest with respect to embodiments of the present invention. Since interchange cards work with an entire band of wavelengths, it is preferable to perform any comparisons based on bands rather than wavelengths. However, it is important to note that embodiments of the present invention described below work, or are functional, for any size of band of one or more wavelengths.

FIG. 1C illustrates an example of an interchange card having two band filters. An interchange card assists in delivering individual bands to their destination, since bands eventually have to be split from each other in order to reach their respective destination. A given fiber could contain, for example, 32 wavelengths consisting of 8 channels/bands of 4 contiguous wavelengths. An interchange card is similar to a demultiplexer/multiplexer in the electrical domain and essentially consists of two back-to-back band filter cards.

In FIG. 1C, wavelength bands (equivalently referred to herein simply as “bands”) B1 and B2 are shown to be incident to the interchange card. In practicality, other bands B3-B5, or any number of other bands, may also be incident to the interchange card. In this example, we will assume that there are five bands B1-B5 incident to the interchange card, even though only two are illustrated in FIG. 1C. Each of these bands has data that needs to be diverted to distinct destinations. In order to accomplish this in the optical domain, in one situation a first band filter is used to strip off the wavelengths in the B1 band. This allows the interchange card to pass through everything except B1 band wavelengths, or to drop B1 band wavelengths. This process is preferably repeated, if necessary, for the wavelengths of each of bands B2-B5.

However, since the B1 band wavelengths are stripped off in the first band filter, those same wavelengths may be added at the second band filter. Once again, this may also apply to each of the other wavelength bands B2-B5. As such, the B1 band wavelengths can be added separately from any other wavelengths and may be routed to their appropriate destination. In FIG. 1C, B5 band wavelengths are added at the second band filter to B1 band wavelengths and provided at the output of the band interchange. This same procedure described above could also be used in conjunction with individual channels as opposed to bands.

Interchange cards provide a solution that doesn't convert signals to the electrical domain, therefore eliminating a need for transponders. The elimination of transponders is an advantage of the use of interchange cards. By determining which inputs have the most in common with particular outputs and making these pass-throughs as described above, an improved network design may be achieved without needing additional filtering or interchange components.

Embodiments of the present invention will now be described with respect to a preferred non-limiting exemplary implementation of computer software running a network simulation on a general-purpose computer, or any other suitable hardware. Such software, or hardware running such software, will be referred to hereinafter as a link planning tool. However, it is to be understood that many other alternative implementations are possible.

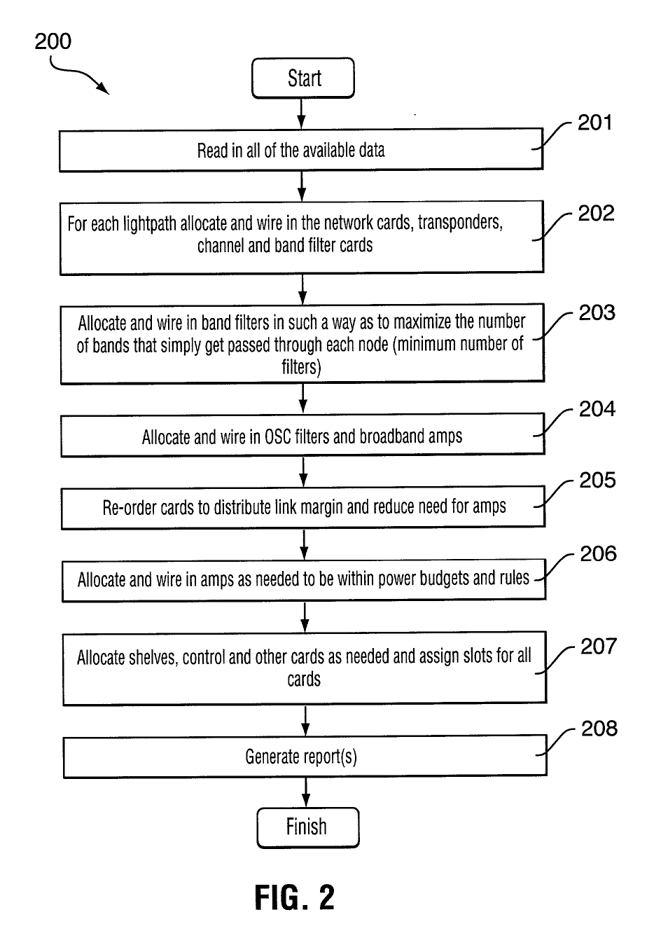

FIG. 2 illustrates a flowchart indicating a high-level overview of steps in a method 200 according to an embodiment of the present invention. Most of these steps will be described in greater detail with respect to subsequent figures. In step 201 of the method 200, data relating to a network situation is read in by the link planning tool. This data is preferably in a suitable format for processing by any suitable means that is employed for reading in the data. Step 202 comprises the task of set card allocation. A set card is simply any type of card that has parameters that are set, or fixed, and with respect to which no parameters may be varied during the network planning process. A set card typically comprises a standardized “end piece” for a lightpath, and several physical cards may together be considered cards at the end of a lightpath. The selection and location of set cards is typically dictated by an end user and generally may not be modified by a network designer or network consultant during the network planning process. In step 202, for each lightpath, network cards are allocated and “wired” in. Since this method advantageously simulates a network layout, the “wiring” of any cards in methods and apparatuses according to an embodiment of the present invention represents a virtual wiring of such components in a software model of a network. Although no physical wires are used in such a simulation, steps are taken such that connections relating to the physical wiring of all components being considered are simulated. For instance, in a method according to an embodiment of the present invention, the method will consider how to connect wires between specific ports of the network components involved. Preferably, in step 202, any related transponders, channel and band filter cards are also allocated and wired in, each of these cards preferably being identified as set cards.

In order to facilitate such virtual wiring, network components are preferably described with respect to a plurality of parameters. Such parameters may include, for example: power loss; standard deviation; tolerances; and legal or standards-based requirements. Such a description is preferably consolidated into an object model, such as a network component object model provided for each network component. A network object model may then preferably be compiled based on the network component object model for each component of the network. A network object model preferably comprises a characterization of every network component and every legitimate interconnection relating to a network component.

The network component object model may be constructed in any suitable programming language or environment into a format suitable for use by an apparatus for performing the necessary calculations with such component model. The object model is preferably chosen such that a third party, such as a network component manufacturer or reseller, would be able to construct a network component object model; that way, a particular component or set of components could be considered in embodiments of the present invention. Also, a network component manufacturer or reseller would be able to provide a network component object model of a new or enhanced network component prior to production; simulations could be performed according to embodiments of the present invention and provide useful information to the network component manufacturer or reseller.

The data model adopted in a preferred embodiment of the present invention is based on a unidirectional set of components, which represent the cards in the system. Each card is represented by one or more of these unidirectional components. All of the components that make up a single card know of their relationship to each other, but this relationship is only used when placing or counting the cards in the physical world. This relationship is referred to as shadowing. All of the components that make up a card will shadow each other. In this way, an inherently unidirectional lightpath will only be concerned with the power levels of the components it passes through and does not need to be aware of the lightpaths moving in the other direction. This eliminates the need to refer to the east-west directions and allows networks where the two directions for a connection are routed through different physical fibers.

In FIG. 2, steps 201 and 202 generally identify a network in somewhat generic terms. Step 203 identifies a network in more specific terms and comprises the task of interchange card allocation. In step 203, band filters are allocated and wired in so as to maximize the number of bands that are passed through each node. In so doing, the number of filters is minimized. In optional step 204, one or more optical service channel (OSC) filters, broadband amplifiers, and dispersion compensation modules (DCMs) is wired in. An optical service channel is a channel used to carry general information about a network. A dispersion compensation module is a type of single-mode optical fiber designed for use in high-bit-rate, long-distance telecommunications systems too clean up a signal by compensating for dispersion; for example, a DCM may comprise a silica-clad fiber having a segmented core that lowers the slope of the dispersion curve at 1550 nm, the wavelength at which silica-based glasses reach their lowest attenuation. Step 205 comprises an optional, yet preferable, step of reordering the cards in the simulation in order to distribute a link margin and reduce the need for amplifiers.

The link margin is the amount of power available in excess of the required power to get the signal from the transmitter to the receiver. The link budget is the difference between the receiver's minimum power sensitivity and the power being added in the lightpath between the beginning at the transmitter and the end at the receiver. If the margin is negative, the signal will not be strong enough to be understood at the receiver; if the link margin is positive, then there is extra power that was not necessary to get the signal to the receiver coherently.

The first decision criterion for how to order the filters is to observe the available margin for the lowest margin lightpath at each filter and to swap filters where the positive margin available in one is sufficient to bring the negative margin filter into the positive. A further step determines whether there is an ordering between the remaining filters that will distribute any available margin so as to reduce the need for amplifiers to simpler and cheaper amplifiers instead of the more expensive and larger ones. In step 205, it is advantageously determined which wavelengths are “lit up” on fiber and components of a specific network being considered, and the power and standard deviation of a plurality of lightpaths at a plurality of points in the network are calculated and stored. Preferably, the power and standard deviation of every lightpath at every point in the network are calculated and stored. There is a possible decision point at every point in the network. It is possible to calculate each decision point independently as needed, but the total computational cost of such calculation is very high. It has been found to be much easier overall, and to have less of a computational cost, to perform all such calculations up front and only recalculate as needed.

In step 206, suitable amplifiers are allocated and wired in as needed. Per-band amplifiers are preferably placed for each lightpath in sequence as described in the flowcharts. Each inline per-band amplifier placement may potentially invalidate every other inline per-band amplifier, so there isn't just a single initial amplifier placement. Rules preferably dictate that on any specific lightpath, a drop per-band amplifier is tried first (if it is permitted for that lightpath), then an add per-band amp (if it is permitted for that lightpath), then inline per-band amps are placed in the lightpath at the last spot if it is permitted in that lightpath. The algorithm continues in this fashion until no further amp placement is possible, and resolves any deadlock conditions before its completion. Such allocation and wiring in is preferably performed within customer parameters, such as power budgets and rules. The location of broadband amplifiers is generally defined by the customer, and preferably optimized through iteration. The location of per-band amplifiers is preferably performed automatically in the most optimal locations the tool can find.

In step 207, the shelves, control and other cards are allocated as needed, and slots are assigned for all cards. Such specific allocation is possible due to the detailed wiring information that has been determined in previous steps. The allocations in step 208 are performed for all cards that will be needed in a shelf, be they electrical or in the optical domain. Finally, in step 208, one or more reports are generated. An example of such a report is a generated network database, also known as an export database, though many other reports are possible and will be described later. Such reports are typically generated from information contained in a system's internal database. A system's internal database may originally be populated by an export database similar to the export database generated as an output report. Such export database and other reports are advantageously implemented in a suitable format for subsequent use, such as the eXtensible Markup Language (XML).

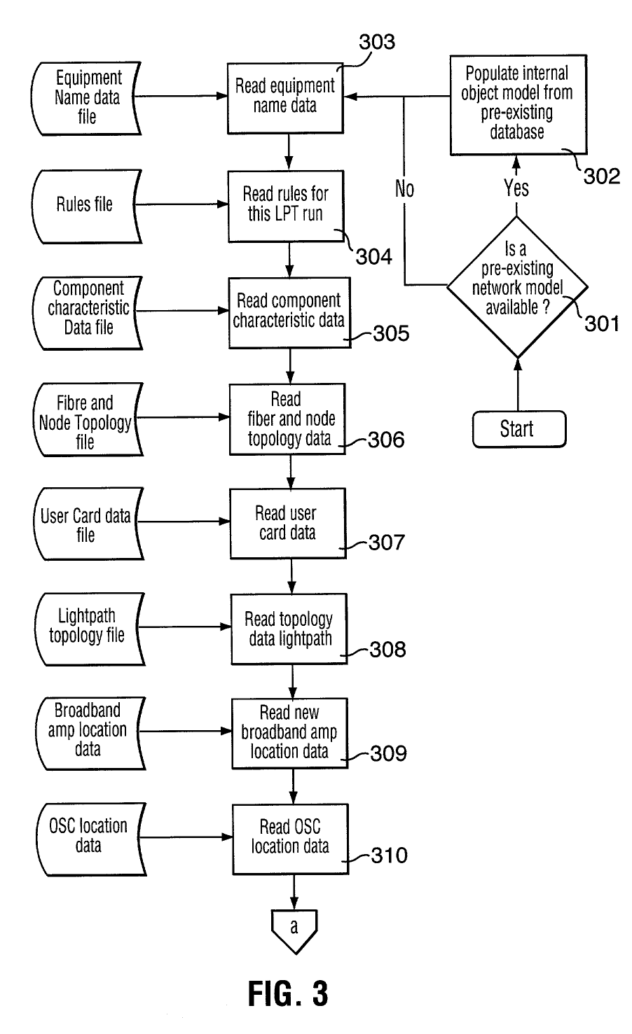

Turning now to FIG. 3, the steps illustrated therein indicate a plurality of possible sub-steps relating to data gathering or input in the method of FIG. 2, i.e. step 201. In the example shown in FIG. 3, many of the data are preferably gathered as pre-existing data files. In step 301, a determination is made whether a pre-existing network model is available. If the answer is yes, an internal object model is populated from a pre-existing database in step 302. As such, information regarding a specific known network could be “imported”. If the answer from step 301 is no, such population cannot be performed.

In steps 303-310, various types of data are shown to be gathered or imported by the link planning tool. Although it is preferable that all such types of data that are available are gathered, it is possible according to alternate embodiments of the present invention that only certain of these types of data would need to be gathered. As illustrated in FIG. 3, steps 303-310 comprise the reading, gathering, or obtaining of the following data by the link planning tool: equipment name data (step 303); rules data (step 304); component characteristic data (step 305); fiber and node topology data (step 306); user card data (step 307); lightpath topology data (step 308); broadband amplifier location data (step 309); and OSC location data (step 310). With respect to steps 306-310, the steps may preferably comprise the step of instantiating such data, the term instantiating referring to creating an object representation of an abstract object or a physical network component. In object-oriented programming, it is possible to instantiate a class to create an object, a concrete instance of the class.

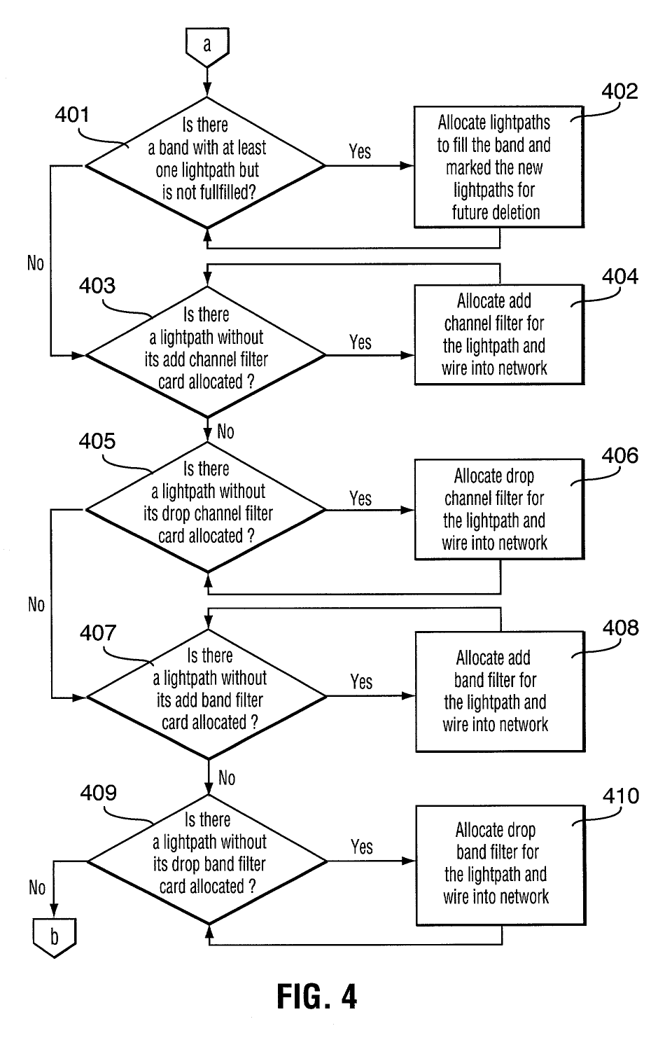

Although it is preferred that such data would be gathered in the logical order presented herein, it is possible according to alternate embodiments of the present invention that such data would be gathered in a different order, so long as processing of the data is feasible. The order of data gathering is typically inconsequential since further steps in method 200 will generally not be performed until all desired data is collected. Following the gathering of data illustrated in FIG. 3, the method proceeds to a point identified as “a”, shown also in FIG. 4.

FIG. 4 illustrates a flowchart indicating steps relating to set card allocation in the method of FIG. 2. The steps illustrated in FIG. 4 concern the allocation of fixed, or set, cards or components. This allocation sets up the standardized “end pieces” for all lightpaths. From point “a”, a determination is made in step 401 as to whether there is a band with at least one lightpath that is not filled. If the determination in step 401 is positive, the method proceeds to step 402. In step 402, any lightpaths are allocated to fill the band and the new lightpaths are marked for future deletion from the list of unfilled lightpaths. Steps 401 and 402 may be repeated iteratively until there are no bands with at least one lightpath that is not filled. Step 402 is optional and can be skipped at the users request if unused channels do not need to be engineered.

If a negative determination is made from step 401, the method proceeds to step 403. In step 403 another determination is made as to whether there is a lightpath without its add channel filter card allocated. If the determination in step 403 is positive, the method proceeds to step 404. In step 404, an add channel filter is allocated for the lightpath and is wired into the network. Once again, steps 403 and 404 may be repeated iteratively until there is no lightpath without its add channel filter card allocated.

If a negative determination is made in step 403, the method proceeds to step 405. In step 405 another determination is made as to whether there is a lightpath without its drop channel filter card allocated. If the determination in step 405 is positive, the method proceeds to step 406. In step 406, a drop channel filter is allocated for the lightpath and is wired into the network. Steps 405 and 406 may be repeated iteratively until there is no lightpath without its drop channel filter card allocated.

If a negative determination is made from step 405, the method proceeds to step 407. In step 407 another determination is made as to whether there is a lightpath without its add band filter card allocated. If the determination in step 407 is positive, the method proceeds to step 408. In step 408, an add band filter is allocated for the lightpath and is wired into the network. Steps 407 and 408 may be repeated iteratively until there is no lightpath without its add band filter card allocated.

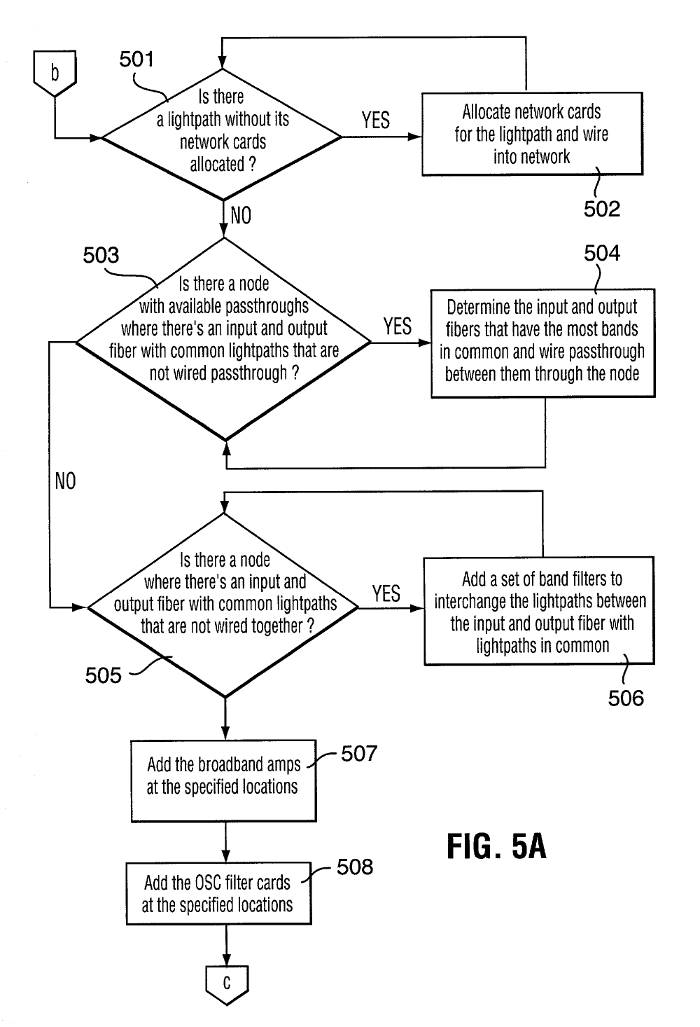

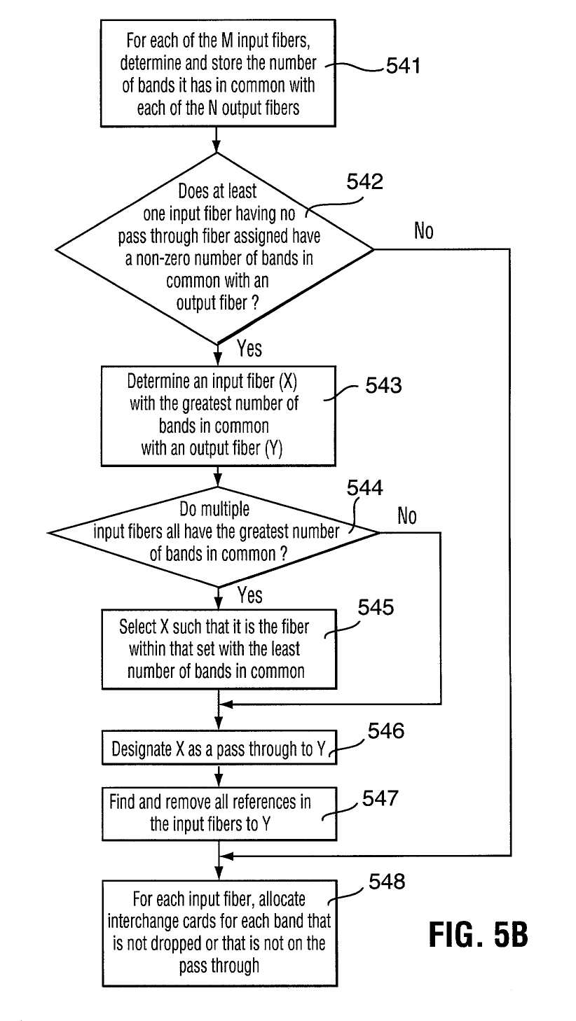

If a negative determination is made in step 407, the method proceeds to step 409. In step 409 another determination is made as to whether there is a lightpath without its drop band filter card allocated. If the determination in step 409 is positive, the method proceeds to step 410. In step 410, a drop band filter is allocated for the lightpath and is wired into the network. Steps 409 and 410 may be repeated iteratively until there is no lightpath without its drop band filter card allocated. If a negative determination is made in step 409, the method proceeds to point “b”, shown also in FIG. 5A.

FIG. 5A illustrates a flowchart indicating steps relating to network card and interchange card allocation in the method of FIG. 2. It is to be noted that steps 501 502 relate to network card, or set card, allocation, steps 503-506 relate to interchange card allocation, and that steps 507-508 relate to allocation of other amplifiers and cards.

From point “b”, a determination is made in step 501 as to whether there is a lightpath without its network cards allocated. If the determination is positive, in step 502, any network cards are allocated for the lightpath and are wired into the network.

Steps 501 and 502 may be repeated iteratively until there is no lightpath without its network cards allocated.

Once a negative determination may be made from step 501, the method proceeds to the steps relating to interchange card allocation. In step 503 another determination is made as to whether there is a node with available passthroughs having an input and output fiber with common lightpaths that are not wired passthrough. If the determination is positive, in step 504, the input and output fibers that have the most bands in common are determined and a passthrough is wired up between them through the node. Once again, steps 503 and 504 may be repeated iteratively until there is no node with available passthroughs having an input and output fiber with common lightpaths that are not wired passthrough.

Once a negative determination may be made from step 503, in step 505 another determination is made as to whether there is a node having an input and output fiber with common lightpaths that are not wired together. If the determination is positive, in step 506, a set of band filters is added to interchange the lightpaths between the input and output fiber with lightpaths in common. Steps 505 and 506 may be repeated iteratively until there is no node having an input and output fiber with common lightpaths that are not wired together.

In step 507, any broadband amplifiers that have been recommended are added at the specified locations. In step 508, any OSC filter cards that have been recommended are added at the specified locations. The method may alternatively include a step, not shown in FIG. 5A, of adding, at the specified locations, any DCM cards that have been recommended. In a particular embodiment, a suitable means or apparatus automatically determines the specified locations. Alternatively, the specified locations may be determined by the network planner, or by another apparatus or entity. For the broadband amps, information from a previous run of the link planning tool may be used to decide where several per-band amplifiers could be replaced by one broadband amp. The link planning tool reports provide recommendations regarding broadband amp placement.

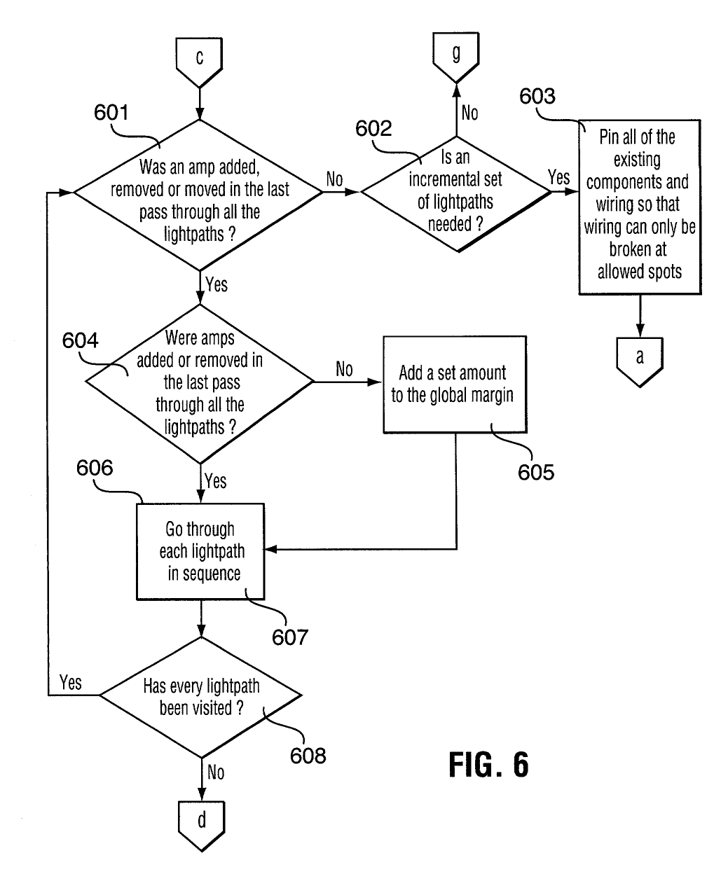

Embodiments of the present invention allow for either an automatic compliance with such recommendations, or alternatively a less strict adherence to the recommendations and use thereof simply as a guide. The network design may also have natural places where the network planner would like to put the broadband amps. For the OSC cards, the network planner makes the decision for which links should have the OSC cards so that the network can be properly monitored over the data channel it provides. Since it is, in effect, an overlay data network on top of the optical network for monitoring purposes, it may be left entirely up to the network planner to decide what the network should look like. Following step 508, the method according to an embodiment of the present invention proceeds to point “c” in the method, as also shown in FIG. 6.

FIG. 5B illustrates a flowchart indicating steps in a method of assigning pass through connections within a node according to an embodiment of the present invention. The method in FIG. 5B provides a more detailed discussion of the steps 504-506 from FIG. 5A, particularly with respect to step 504.

In step 541, for each of the M input fibers, the number of bands the input fiber has in common with each of the N output fibers is determined, and preferably stored. Step 542 performs a check to ensure that subsequent steps 543-545 are performed as long as at least one input fiber that has no pass through fiber assigned has a non-zero number of bands in common with an output fiber. If step 542 results in a negative determination, the method proceeds to step 548.

If step 542 results in a positive determination, the method proceeds to step 543. In step 543, a determination is made in order to find an input fiber (X) with the greatest number of bands in common with an output fiber (Y). Step 544 performs a check to verify whether multiple input fibers all have the greatest number of bands in common. If step 544 results in a positive determination, the method proceeds to step 545. In step 545, X is selected such that it is the fiber within that set with the least number of output fibers in common. In this step, it is preferable to leave the input fibers that have the greatest chance of having a match in later iterations of the algorithm. If step 544 results in a negative determination, or if step 545 has been executed, the method proceeds to step 546.

In step 546, X is designated as a pass through to Y. In step 547, all references in the input fibers to Y are found and removed. Following step 547, the method returns back to step 542 to perform the check described above. If it is found that there is not at least one input fiber that has no pass through fiber assigned having an on-zero number of bands in common with an output fiber, the method proceeds to step 548. In step 548, for each input fiber interchange cards are allocated for each band that is not dropped or that is not on the pass through.

Although the heuristic method in FIG. 5B is particularly well suited for the minimization of the number of interchange cards, it may also be applied to an optical cross-connect. By assigning pass through connections in a manner that minimizes the number of wavelengths that need to be diverted within a cross-connect, it is possible to advantageously reduce the required complexity of the switch.

Following execution of steps in FIG. 5A, it may be said that a first-order optimization of a network design has been produced. At this point, the simulation can guarantee that the light will reach the proper destination for transporting optical data. However, it may be questionable as to whether the light will be detectable once it reaches its destination. If there is not sufficient power to make the light detectable at its destination, one option is to “steal” some power from one or more other shelves or cards along a given path. Therefore, it would be advantageous to verify, for any wavelengths having spare power, whether re-ordering of the cards in the network simulation could possibly reduce the number of amplifiers required. Such an optimization would preferably be performed with respect to network constraints or rules defined at the outset, either by a customer, network planner or third party. One such pass for the lightpath-ending band filter cards is performed in step 205.

FIGS. 6-9 illustrate steps in the optimization of amplifier allocation and placement. In terms of allocating amplifiers, there are three main types of amplifiers to be considered: drop amplifiers; add amplifiers; and inline amplifiers. Each of these amplifiers is preferably a band amplifier. When it is determined that amplifiers must be added, the order of preference is as follows: drop amplifiers; add amplifiers; and inline amplifiers. A drop amplifier should be placed just before a channel filter card.

A channel filter card takes a band of wavelengths and splits the individual wavelengths to separate ports (and combines in the other direction), while a band filter card takes all the wavelengths in the spectrum and splits out an individual band (and combines in the other direction). By cascading a band filter then channel filter you can remove the set of wavelengths as a unit, then split them each onto their individual ports.

An add amplifier should be placed just after a channel filter on the launch end. However, all intermediate receivers should be considered with respect to acceptable range and standard deviation in determining add amplifier placement. Inline amplifiers may be added anywhere between a first band filter card and a final band filter card. However, in using an inline amplifier, it is necessary to take a band off the card, drop it, and add it back; this process affects the power of all other bands. As such, the use and placement of inline amplifiers can be quite complicated.

It is also possible, with the addition of amplifiers, to encounter a situation wherein there is a deadlock when one added amplifier collides with another added amplifier. If a certain threshold is surpassed, the best possibility to avoid collision may be to move all amplifiers forward and let them all pass. The possibility of the occurrence of such situations involving much calculation and consideration highlights the need for automated methods for amplifier placement, as will be described with respect to FIGS. 6-9 below.

FIG. 6 illustrates a flowchart indicating steps relating to amplifier allocation and placement in the method of FIG. 2. This figure relates to steps in a general method relating to amplifier allocation, regardless of the type of amplifier. FIGS. 6-8 deal with amplifier allocation for specific types of amplifier.

From point “c” in FIG. 6, a determination is made in step 601 as to whether an amplifier was added, removed or moved in the last pass through all the lightpaths. If the determination in step 601 is negative, a subsequent determination is made in step 602 as to whether an incremental set of lightpaths is needed. If the determination in step 602 is negative, the method proceeds to point “g”, also shown in FIG. 20. Proceeding to point “g” indicates that optimization of amplifier allocation and placement has been substantially completed.

If the determination in step 602 is positive, the method proceeds to step 603, where all of the existing components and wiring are protected, or pinned, so that the wiring can only be broken at certain allowed spots. In a preferred embodiment, no wiring is allowed to be broken where there is one ore more pre-existing lightpaths passing through it; any other wiring break would be permitted in such an arrangement. The basic approach in this preferred embodiment is that existing lightpaths cannot be interrupted simply in order to add new ones. Following execution of step 603, the method proceeds back to point “a” of the method.

If a positive determination is made in step 601, the method proceeds to step 604. In step 604, a determination is made as to whether amplifiers were added or removed in the last pass through all the lightpaths. If the determination in step 604 is negative, the method proceeds to step 605, wherein a set amount is added to the global margin. The global margin preferably starts at zero by default, but this may be set at another value, or may alternatively be changed by the user. The set amount added to the global margin remains zero for a certain number of iterations. The default number of iterations to stay zero is preferably determined before-hand, but may alternatively be changed by the user. The larger the number of iterations before the margin starts getting added to, the closer to an optimal solution you get (but the longer the tool needs to run). Once global margin starts getting added to, the default increment is usually predetermined, but may alternatively be overridden by the user. The smaller the increment, the closer to an optimal solution but the longer the run. A balance between the proximity and the length of the run may be sought when determining the default increment, either in advance or by a user. This mechanism resolves the deadlock condition described earlier.

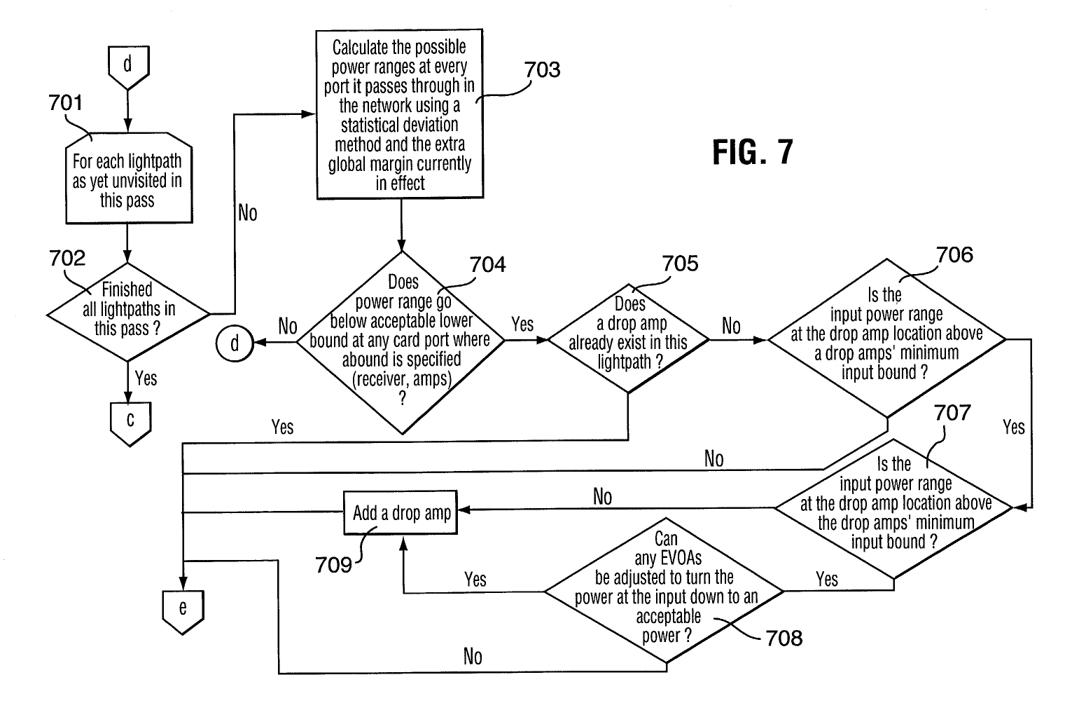

A positive determination from step 604, or completion of step 605, leads to step 606, in which each lightpath is gone through in sequence. In step 607, a determination is made as to whether every lightpath has been visited. If step 607 yields a positive determination, the method returns to step 601. If step 607 yields a negative determination, the method proceeds to point “d”, as also shown in FIG. 7.

FIG. 7 illustrates a flowchart indicating steps relating to drop amplifier allocation in the method of FIG. 2. As was mentioned earlier, drop amplifier addition is preferred over add amplifier or inline amplifier addition. Consequently, it is preferable to investigate the possibility of adding a drop amplifier before other types.

From point “d” in FIG. 7, step 701 ensures that subsequent steps in FIG. 7 are performed for each lightpath that is unvisited as of yet in a particular pass. In step 702, a determination is made whether all lightpaths have been visited, or alternatively whether such visitation is finished, in a particular pass. If a positive determination is made in step 702, the method proceeds to point “c” of the method, also shown in FIG. 6.

If step 702 results in a negative determination, the method proceeds to step 703. In step 703, the possible power ranges are calculated at every card port the lightpath passes through in the network using a statistical deviation method and the extra global margin currently in effect. Following step 703, a determination is made in step 704 as to whether the power ranges measured in step 703 go below an acceptable lower bound at any card port where such a bound is specified, for example at a receiver or at amplifiers Typically, a component manufacturer would provide the acceptable ranges for their components. If step 704 results in a negative determination, the method proceeds to point “d” of the method, as shown before step 701.

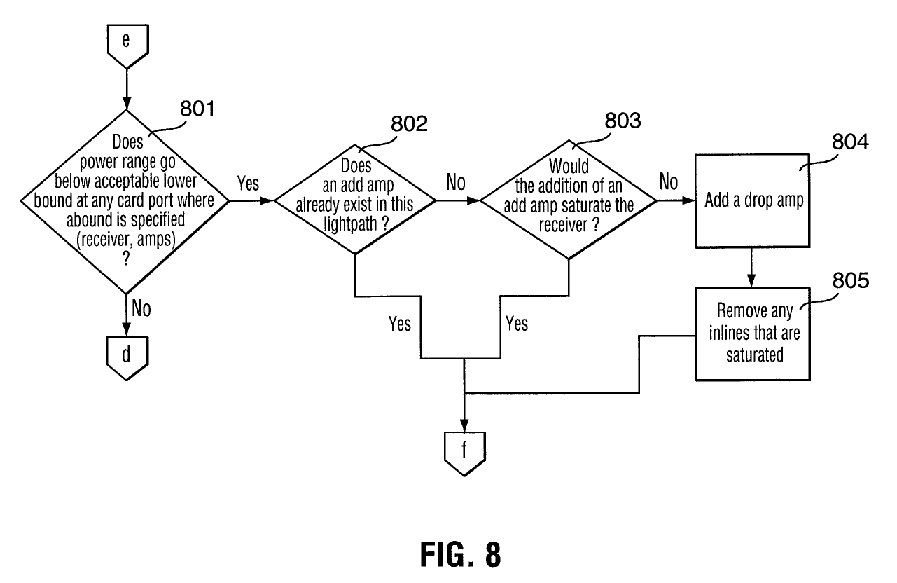

If step 704 results in a positive determination, a subsequent determination is made in step 705 as to whether a drop amplifier already exists in a particular lightpath being considered. If step 705 results in a positive determination, the method proceeds to point “e” of the method, also shown in FIG. 8. If step 705 results in a negative determination, the method proceeds to step 706.

In step 706, a determination is made as to whether the input power range at a drop amplifier location is above a drop amplifier's minimum input bound. If step 706 results in a negative determination, the method proceeds to point “e” of the method, also shown in FIG. 8. If step 706 results in a positive determination, the method proceeds to step 707.

In step 707, a determination is made as to whether the input power range at a drop amplifier location is above the drop amplifier's maximum input bound. If step 707 results in a positive determination, the method proceeds to step 708. In step 708, a determination is made as to whether it is possible to adjust any electrical variable optical attenuators (EVOAs) in the network to reduce the power at the drop amplifier input to an acceptable power level.

If step 708 results in a positive determination, or if step 707 results in a negative determination, the method proceeds to step 709, where a drop amplifier is added. If step 708 results in a negative determination, or if step 709 has been completed, the method proceeds to point “e” in the method, also shown in FIG. 8.

FIG. 8 illustrates a flowchart indicating steps relating to add amplifier allocation in the method of FIG. 2. From point “e” of the method, a determination is made in step 801 as to whether a power range goes below an acceptable lower bound at any card port where such bound is specified, for example at a receiver or at amplifiers. Such bounds are preferably specified by the component manufacturer. The bounds are then preferably captured in component data and is shipped with the tool. If new components are added to the list, then the manufacturer could provide the data and the data could be updated accordingly, either by the customer or by the network consultant. The main criterion for deciding to try to place either an add or drop amp is the same—there is a component outside of its receiver sensitivity somewhere downstream from the amp in question. If step 801 results in a negative determination, the method proceeds to point “d” of the method, also shown in FIG. 7.

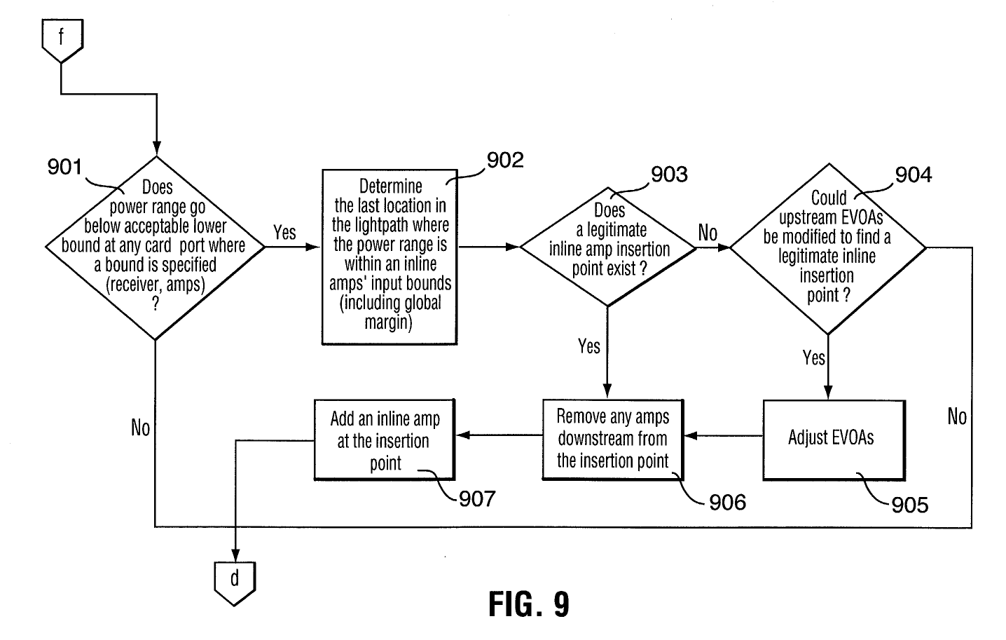

If step 801 results in a positive determination, the method proceeds to step 802. In step 802, a determination is made as to whether an add amplifier already exists in a particular lightpath being considered. If step 802 results in a positive determination, the method proceeds to point “f” of the method, also shown in FIG. 9. If step 802 results in a negative determination, the method proceeds to step 803.

In step 803, a determination is made as to whether the addition of an add amplifier would saturate a given receiver. The receiver is preferably located in the network card at the far end of the lightpath. If step 803 results in a positive determination, the method proceeds to point “f” of the method, also shown in FIG. 9. If step 803 results in a negative determination, the method proceeds to step 804. In step 804, an add amplifier is added, since the preferred requirements for such addition have been confirmed through the previous steps in the method. In step 805, any saturated inline amplifiers are removed. Following execution of step 805, the method proceeds to point “f” of the method, also shown in FIG. 9.

FIG. 9 illustrates a flowchart indicating steps relating to inline amplifier allocation in the method of FIG. 2. From point “f” of the method, a determination is made in step 901 as to whether a power range goes below an acceptable lower bound at any card port where such bound is specified, for example at a receiver or at amplifiers. Once again, the component manufacturer preferably provides the operational bounds. All of the amps and receivers will have a valid operations input and output range that should be conformed to. If step 901 results in a negative determination, the method proceeds to point “d” of the method, also shown in FIG. 7.

If step 901 results in a positive determination, the method proceeds to step 902. In step 902, a determination is made as to the last location in the lightpath where the power range is within an inline amplifier's input bounds, preferably including global margin. Once that location has been determined, in step 903, a determination is made as to whether a legitimate inline amplifier insertion point exists.

This legitimacy is preferably governed by the rules in effect for this network. Some such rules are typically common to all networks, such as: a requirement to put amps in existing nodes; and a requirement to not break a fiber between nodes in order to insert an amp. Other rules may typically exist for operational simplicity, such as: it is not permitted to insert an inline amp between the drop and add filters of another inline amp. In any case, rules are preferably used to dictate whether an insertion point is legitimate, or permitted.

If step 703 results in a negative determination, the method proceeds to step 904. In step 904, it is determined whether it is possible to modify one or more upstream EVOAs in order to find a legitimate inline amplifier insertion point. If step 904 results in a positive determination, then the method proceeds to step 905, where such EVOAs are adjusted. If step 904 results in a negative determination, the method proceeds to point “d” of the method, also shown in FIG. 7.

If step 903 results in a positive determination, or if execution of step 905 is completed, the method proceeds to step 906. In step 906, any per-band amplifiers that are downstream from the insertion point are removed. Following execution of step 906, in step 907, an inline amplifier is inserted at the insertion point. Following execution of step 907, the method proceeds to point “d” of the method, also shown in FIG. 7.

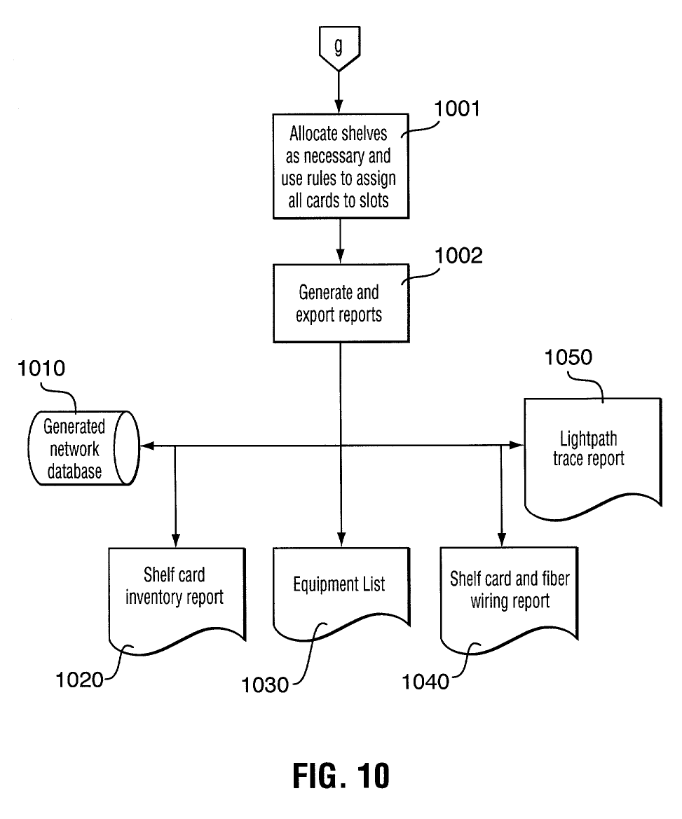

FIG. 10 illustrates a flowchart indicating steps relating to report generation in the method of FIG. 2. The reader is reminded that the method enters into the steps in FIG. 10 only after it has been determined that an amplifier was not added, removed or moved in the last pass through all the lightpaths, and that an incremental set of lightpaths is not needed. Arriving at point “g” in the method indicates that optimization of amplifier allocation and placement has been substantially completed.

From point “g” in the method, in step 1001, shelves are allocated as necessary, i.e. as has been determined by the cards allocated in previous steps in the method. In step 1001, rules are preferably used to assign all cards to slots. Some of these rules may be modified by the network planner or by the client. Some of the cards may be placed only within certain slots in the shelf, and adjacent only to other specific cards. Some of these rules may be defined in the input files and some may be hardcoded. The data that is defined in the data files will typically specify the cards size, type, and possible relationships to other cards. Additionally, the user may use options to have special shelves allocated with only optical cards or only electrical cards in them, or leave slots open for future upgrades.

Following execution of step 1001, in step 1002 any one of a plurality of outputs, such as reports, is generated and exported. Each of such outputs or reports constitutes a concrete, useful and tangible result that may be used in any number of advantageous manners. FIG. 10 illustrates some preferred examples of such reports: a generated network database (1010); shelf card inventory report (1020); equipment list (1030); shelf card and fiber wiring report (1040); and lightpath trace report (1050). Each of these reports is output in a format suitable for end-user use and consideration. Although an electronic version of such a report, such as a text file or a file in any other suitable format, is preferable, a hard copy of such a report may also be produced as an output, either instead of the electronic copy or in addition thereto.

With respect to the generated network database 1010, such a database 1010 comprises network information, preferably comprising all of the information characterizing the network. The database is preferably implemented as an XML file containing all of the information from the network. This preferably includes all the components, the nodes, the fibers, the wiring, the power for every channel at every port, the lightpaths in the network. The generated network database 1010 basically contains a complete object model for the network, referred to previously as a network object model.

Shelf card inventory report 1020 provides a high level view of the shelf without the individual ports or wiring between them. The shelf card inventory report 1020 shows only the card location and is typically used primarily for card insertion prior to wiring.

The equipment list 1030 comprises a report that provides detailed information describing the number of pieces of equipment needed to build a proposed network. Such an equipment list is advantageously utilized in conjunction with Applicant's copending U.S. patent application Ser. No. 10/128,340 entitled “Method and Apparatus for Integrated Network Planning and Business Modeling”. In such an advantageous implementation, embodiments of the present invention are employed as a link planning tool. With a determined network configuration as its input, the link planning tool outputs an equipment list and provides it to a business modeling means, wherein business parameters and network business reports may be generated.

With respect to the shelf card and fiber wiring report 1040, such a report provides information relating to network equipment wiring and assigned card locations. The card locations and inventory are preferably presented in such a manner that a technician would be able to easily construct the proposed network based on the shelf card and fiber wiring report 1040, having been given specific information relating to the intricate wiring and location of cards and equipment in the network. Conventional approaches to network design and proposal typically do not provide such detailed information in an automated manner. The automatic generation of such a report may reduce any degradation in network performance that may be introduced due to improper or un-optimal wiring and card placement in the practical implementation of a desired network.

The lightpath trace report 1050 comprises expected power ranges for every channel at every port within the network. Preferably, the lightpath trace report 1050 shows the final power ranges of each of the lightpaths as it passes through the network.

A sixth output (not shown in FIG. 10) may also be produced. This output comprises a simulation report, providing a high-level description of how the network simulation iteration went. Such simulation report may preferably include information relating to failures that occurred, as well as information regarding the cause of such failures. The simulation report may comprise information for the final iteration, or may alternatively comprise information for all iterations in the simulation.

Since such reports may easily be generated, according to another according to an embodiment of the present invention, different sets of reports may be generated for different sets of customer requirements. Consequently, the simulation tool may provide a customer with an extremely detailed comparison of possible network implementations. This would be particularly useful if a customer is not certain about a particular desired parameter because of some external factor out of their control, such as economic conditions or end-user behavior.

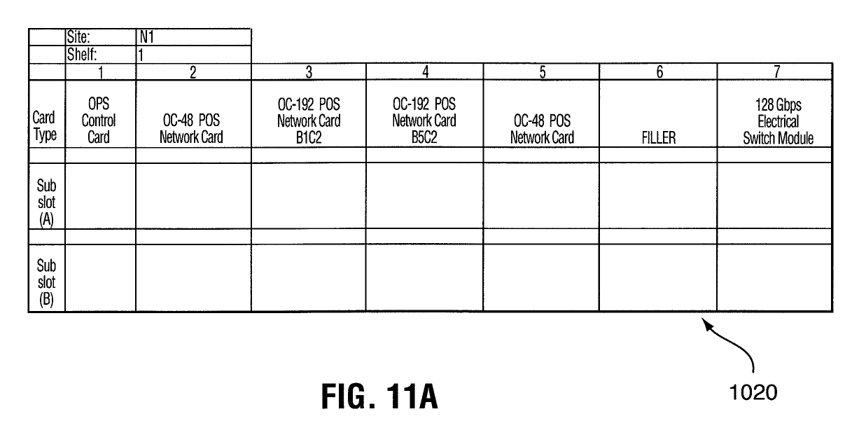

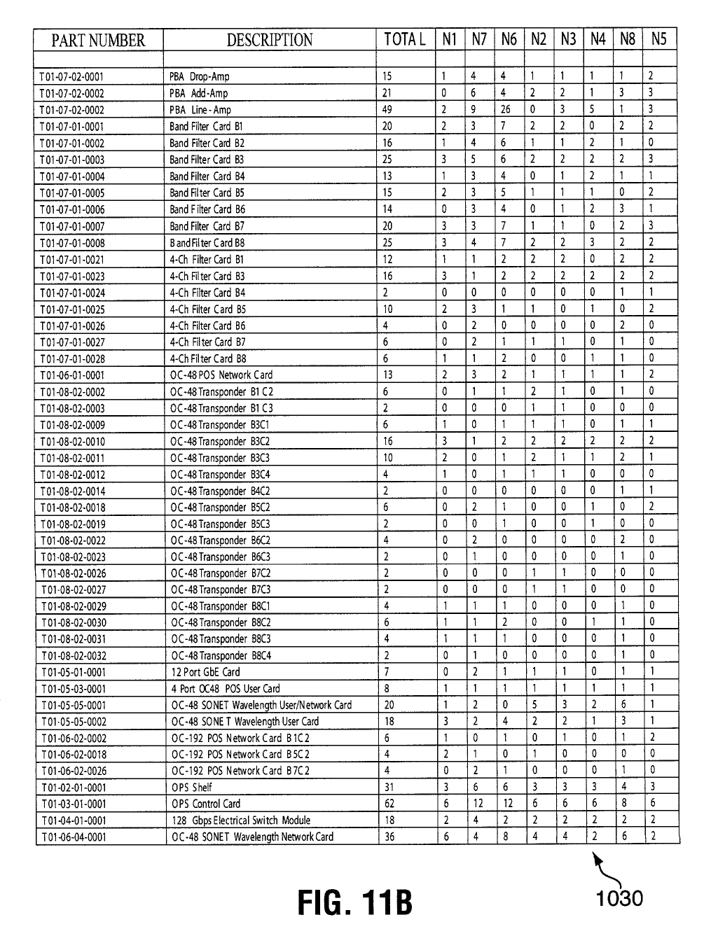

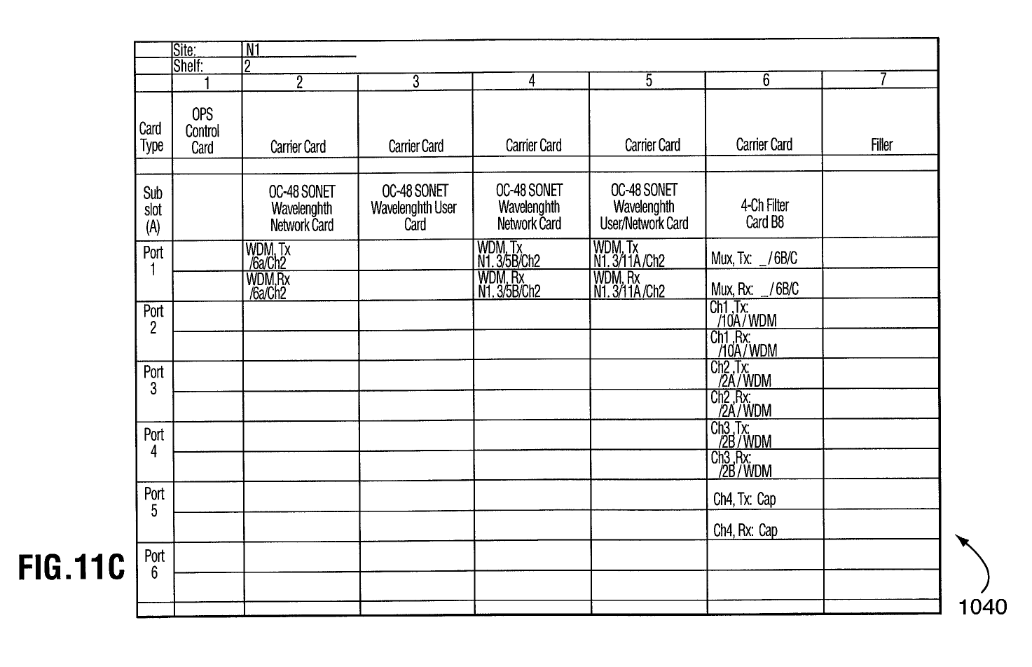

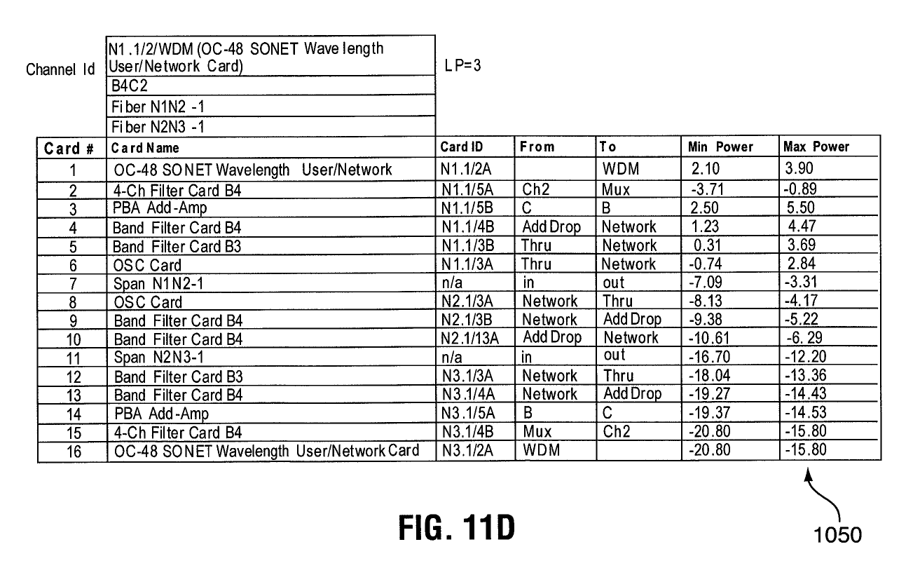

FIGS. 11A-11D illustrate examples of outputs or reports generated in accordance with embodiments of the present invention. Once again, each of such outputs or reports constitutes a concrete, useful and tangible result that may be used in any number of advantageous manners. FIG. 11A illustrates an example of a shelf report 1020, alternatively known as a shelf inventory, as described in accordance with FIG. 10. The shelf report may be used in order to insert cards prior to wiring. The particular example in FIG. 1 A shows a specific card type being identified to be inserted in a particularly identified shelf, in this case identified by number.

FIG. 11B illustrates an example of an equipment list 1030, as described in accordance with FIG. 10. As described earlier, such an equipment list is advantageously utilized in conjunction with Applicant's copending U.S. patent application Ser. No. 10/128,340 entitled “Method and Apparatus for Integrated Network Planning and Business Modeling”. The particular example in FIG. 11B shows the identification of a part number and description for each equipment item, as well an identification of the total number required, and a number required per node for each equipment item.

FIG. 11C illustrates an example of a card and fiber wiring report 1040, alternatively known as a shelf wiring report, as described in accordance with FIG. 10. The particular example in FIG. 11C shows that a great deal of detailed information is provided in respect of the wiring of cards and fibers in accordance with a particular network configuration. Specifically, FIG. 11C shows the specific type of card to be inserted in each sub-slot, and shows the specific type of connection to be used between ports of each of the cards. Such detailed information preferably provided in such a card and fiber wiring report assists in the reduction of errors between network configuration proposal and practical implementation thereof.

FIG. 11D illustrates an example of a lightpath trace report 1050, as described in accordance with FIG. 10. The particular example in FIG. 11D illustrates maximum power and minimum power values being associated with such detailed card information as card number and name, card ID, source and destination for a particular lightpath being considered.

Embodiments of any of the aspects of the present invention can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web).

Of course, some embodiments of the invention may be implemented as a combination of both software (e.g., a computer program product) and hardware. Still other embodiments of the invention may be implemented as entirely hardware, or entirely software (e.g., a computer program product). For example, in a method according to an embodiment of the present invention, various steps may be performed at each of a plurality of computers, other apparatuses having a processing means, or any other suitable apparatus as would be evident to one skilled in the art. These steps may be implemented via software that resides on a computer readable memory located at each of said plurality of computers or other apparatuses having a processing means.

Although various exemplary embodiments of the invention have been disclosed, it should be apparent to those skilled in the art that various changes and modifications can be made which will achieve some of the advantages of the invention without departing from the true scope of the invention.

What is claimed is:

1. A computer-implemented method for network link planning comprising the steps of:
a) obtaining data relating to a simulated optical network;
b) allocating and virtually wiring network components including one or more network cards, channel filter cards, band filter cards and shelves in the network based on said obtained data;
c) assigning slots for all cards in the network; and
d) generating at least one report based on said allocations, assignments and virtual wirings in the network.

2. A method according to claim 1 wherein step b) further comprises allocating and virtually wiring network components including one or more interchange cards and amplifiers.

3. A method according to claim 2 wherein step b) further comprises allocating and virtually wiring network components selected from the group comprising optical service channel (OSC) filter cards, dispersion compensation module (DCM) cards, control cards and electrical cards.

4. A method according to claim 1 wherein said obtained data are selected from the group comprising: equipment name data; rules data; component characteristics data; fiber topology data; node topology data; user card data; lightpath topology data; broadband amplifier location data; and OSC location data.

5. A method according to claim 1 wherein said obtained data comprises a network object model having a network object component model for each network component in the simulated network.

6. A method according to claim 5 wherein step a) comprises the step of populating said network object model from a pre-existing network object model.

7. A method according to claim 3 wherein one or more of said cards allocated and virtually wired in step b) are set cards.

8. A method according to claim 7 wherein the allocation and virtual wiring of set cards in step b) comprises the steps of:
a8) allocating at least one lightpath to fill any band having at least one lightpath not fulfilled;
b8) allocating an add channel filter card for any lightpath without its add channel filter card allocated and virtually wiring said add channel filter card into the network;
c8) allocating a drop channel filter card for any lightpath not having its drop channel filter card allocated and virtually wiring said drop channel filter card into the network;
d8) allocating an add band filter card for any lightpath without its add band filter card allocated and virtually wiring said add band filter card into the network;
e8) allocating a drop band filter card for any lightpath not having its drop band filter card allocated and virtually wiring said drop band filter card into the network; and
f8) allocating a network card for any lightpath not having its network card allocated and virtually wiring said network card into the network.

9. A method according to claim 8 wherein said step a8) comprises the step of marking said at least one allocated lightpath for future deletion.

10. A method according to claim 2 wherein the allocation and virtual wiring of interchange cards in step b) comprises the steps of:
a10) determining a group of input and output fibers having the most bands in common with each other and virtually wiring up a pass-through between said input and output fibers through a network node; and
b10) adding a set of band filters to interchange lightpaths between said input and output fibers for any node at which said input and output fibers are not virtually wired together.

11. A method according to claim 10 wherein step b10) comprises the steps of:
for each of M input fibers, storing a number of bands in common with each of N output fibers;
while at least one input fiber having no pass-through fiber assigned has a non-zero number of bands in common with an output fiber, performing the following steps a11-c11:
a11) determining an input fiber X with the greatest number of bands in common with an output fiber Y;
b11) designating X as a pass-through to Y;
c11) finding and removing all references in the input fibers to Y; and for each input fiber, allocating at least one interchange card for each band that is not dropped or that is not on the pass-through.

12. A method according to claim 10 further comprising the step of adding, at specified locations, one or more network components selected from the group comprising: broadband amplifiers, OSC filter cards, and DCM cards.

13. A method according to claim 10 further comprising the step of:
re-ordering cards in the network so as to distribute a link margin, thereby reducing the need for amplifiers.

14. A method according to claim 13 wherein said step of reordering said cards in the network comprises the steps of:
observing an available margin for the lowest margin lightpath at each filter; and
swapping filters where the positive margin available in one filter is sufficient to convert a negative margin filter to a positive margin filter.

15. A method according to claim 13 wherein said step of reordering said cards in the network comprises the step of:
determining whether there is an ordering between remaining filters that will distribute any available margin so as to reduce a need for large, expensive amplifiers in favor of simpler, less expensive amplifiers.

16. A method according to claim 13 wherein said step of reordering said cards in the network comprises the step of:
determining which wavelengths are lit up on fiber and components of the network.

17. A method according to claim 13 wherein said step of reordering said cards in the network comprises the step of:
calculating and storing the power and standard deviation of a plurality of lightpaths at a plurality of points in the network.

18. A method according to claim 17 wherein said step of calculating and storing comprises calculating and storing the power and standard deviation of every lightpath at every point in the network.

19. A method according to claim 2 wherein, when an incremental set of lightpaths is needed, the allocation and virtual wiring of amplifiers in step b) comprises the step of:
virtually wiring existing network components so that such virtual wiring can only be broken at designated points.

20. A method according to claim 2 wherein, in an iteration through all the lightpaths, the allocation and wiring of amplifiers in step b) comprises the step of:
for each lightpath, adding a set amount to a global margin when amplifiers have been added or removed.

21. A method according to claim 20 wherein each lightpath is examined in sequence in such iteration.

22. A method according to claim 2 wherein the allocation and virtual wiring of amplifiers in step b) comprises the steps of:
calculating possible power ranges at every card port passed through by a particular lightpath; and
adding a drop amplifier if the following conditions are satisfied:
a22) one or more of said power ranges falls below an acceptable lower bound at any port where such lower bound is specified;
b22) a drop amplifier does not already exist in the lightpath; and
c22) an input power range at a proposed drop amplifier location is between a minimum input bound and a maximum input bound.

23. A method according to claim 22 wherein said step of calculating possible power ranges is performed using a statistical deviation method and extra global margin currently available.

24. A method according to claim 22 wherein said condition c22) is replaced by the condition:
c24) an input power range at a proposed drop amplifier location is above a maximum input bound and at least one electrical variable optical attenuator is adjusted so as to render the power range to an acceptable level.

25. A method according to claim 2 wherein the allocation and virtual wiring of amplifiers in step b) comprises the steps of:
calculating possible power ranges at every card port passed through by a particular lightpath; and
adding an add amplifier if the following conditions are satisfied:
a25) one or more of said power ranges falls below an acceptable lower bound at any port where such lower bound is specified;
b25) an add amplifier does not already exist in the lightpath; and
c25) the addition of an add amplifier would not saturate a receiver.

26. A method according to claim 25 further comprising the step of removing any inline amplifier that is saturated.

27. A method according to claim 2 wherein the allocation and virtual wiring of amplifiers in step b) comprises the steps of:
calculating possible power ranges at every card port passed through by a particular lightpath;
determining a location in the lightpath where the power range was last within an inline amplifier's input bounds when at least one of said power ranges falls below an acceptable lower bound at any port where such lower bound is specified;
determining that a legitimate inline amplifier insertion point exists;
removing any amplifier downstream from said insertion point; and
adding an inline amplifier at said insertion point.

28. A method according to claim 27 wherein, if a legitimate inline amplifier insertion point is not initially found, at least one upstream electrical variable optical attenuator is adjusted so as to create such legitimate inline amplifier insertion point.

29. A method according to claim 27 wherein said inline amplifier's input bounds include global margin.

30. A method according to claim 27 wherein the steps in claim 27 are performed if one or more of said power ranges falls below an acceptable lower bound at any port where such lower bound is specified, and if one of the following conditions is satisfied:
an add amplifier already exists in the lightpath; or
addition of an add amplifier would saturate the receiver.

31. A method according to claim 1 wherein said report is selected from the group comprising: generated network database; shelf card inventory report; equipment list; shelf card and fiber wiring report; lightpath trace report; and simulation report.

32. A method according to claim 1 wherein said simulated optical network is a mesh network.

33. A method according to claim 1 wherein said simulated optical network comprises at least one electronic network component.

34. A system for network link planning comprising:
means for obtaining data relating to a simulated optical network;
means for allocating and virtually wiring network components including one or more network cards, channel filter cards, band filter cards and shelves in the network based on said obtained data;
means for assigning slots for all cards in the network; and
means for generating at least one report based on said allocations, assignments and virtual wirings in the network.

35. A computerized system for network link planning comprising:
means for obtaining data relating to a simulated optical network;
means for allocating and virtually wiring network components including one or more network cards, channel filter cards, band filter cards and shelves in the network based on said obtained data;
means for assigning slots for all cards in the network; and
means for generating at least one report based on said allocations, assignments and virtual wirings in the network.

36. A system according to claim 35 wherein said means for allocating and virtually wiring said network components is adapted to allocate and virtually wire one or more network components selected from the group comprising:
interchange cards; amplifiers; optical service channel (OSC) filter cards;
dispersion compensation module (DCM) cards; control cards; and electrical cards.

37. A system according to claim 35 wherein said obtained data are selected from the group comprising: equipment name data; rules data; component characteristics data; fiber topology data; node topology data; user card data; lightpath topology data; broadband amplifier location data; and OSC location data.

38. A system according to claim 35 wherein said obtained data comprises a network object model having a network object component model for each network component in the simulated network.

39. A system according to claim 38 wherein said means for obtaining data relating to a simulated optical network further comprises:
means for importing a pre-existing network object model; and
means for populating said network object model from said pre-existing network object model.

40. A system according to claim 36 wherein one or more of said cards allocated and virtually wired by said means for allocating and virtually wiring said network components are set cards.

41. A system according to claim 38 further comprising means for allocating and virtually wiring such set cards, said means for allocating and virtually wiring such set cards being adapted to perform the following steps:
a41) allocating at least one lightpath to fill any band having at least one lightpath not fulfilled;
b41) allocating an add channel filter card for any lightpath without its add channel filter card allocated and virtually wiring said add channel filter card into the network;
c41) allocating a drop channel filter card for any lightpath not having its drop channel filter card allocated and virtually wiring said drop channel filter card into the network;
d41) allocating an add band filter card for any lightpath without its add band filter card allocated and virtually wiring said add band filter card into the network;
e41) allocating a drop band filter card for any lightpath not having its drop band filter card allocated and virtually wiring said drop band filter card into the network; and
f41) allocating a network card for any lightpath not having its network card allocated and virtually wiring said network card into the network.

42. A system according to claim 41 wherein said means for allocating and virtually wiring such set cards is further adapted to perform the step of marking said at least one allocated lightpath for future deletion.

43. A system according to claim 36 wherein said means adapted for allocation and virtual wiring of interchange cards is further adapted to perform the following steps:
a43) determining a group of input and output fibers having the most bands in common with each other and virtually wiring up a pass-through between said input and output fibers through a network node; and
b43) adding a set of band filters to interchange lightpaths between said input and output fibers for any node at which said input and output fibers are not virtually wired together.

44. A system according to claim 43 wherein said means adapted for allocation and virtual wiring of interchange cards is further adapted to perform the following steps as part of step b43):
for each of M input fibers, storing a number of bands in common with each of N output fibers;
while at least one input fiber having no pass-through fiber assigned has a non-zero number of bands in common with an output fiber, performing the following steps a44-c44:
a44) determining an input fiber X with the greatest number of bands in common with an output fiber Y;
b44) designating X as a pass-through to Y;
c44) finding and removing all references in the input fibers to Y; and
for each input fiber, allocating at least one interchange card for each band that is not dropped or that is not on the pass-through.

45. A system according to claim 43 further comprising means for adding, at specified locations, one or more network components selected from the group comprising: broadband amplifiers, OSC filter cards, and DCM cards.

46. A system according to claim 41 further comprising means for re-ordering cards in the network so as to distribute a link margin, thereby reducing the need for amplifiers.

47. A system according to claim 46 wherein said means for reordering said cards in the network further comprises:
means for observing an available margin for the lowest margin lightpath at each filter; and
means for swapping filters where the positive margin available in one filter is sufficient to convert a negative margin filter to a positive margin filter.

48. A system according to claim 46 wherein said means for reordering said cards in the network further comprises:
means for determining whether there is an ordering between remaining filters that will distribute any available margin so as to reduce a need for large, expensive amplifiers in favor of simpler, less expensive amplifiers.

49. A system according to claim 46 wherein said means for reordering said cards in the network further comprises:
means for determining which wavelengths are lit up on fiber and components of the network.

50. A system according to claim 46 wherein said means for reordering said cards in the network further comprises:
means for calculating and storing the power and standard deviation of a plurality of lightpaths at a plurality of points in the network.

51. A system according to claim 50 wherein said means for calculating and storing comprises means for calculating and storing the power and standard deviation of every lightpath at every point in the network.

52. A system according to claim 36 wherein, when an incremental set of lightpaths is needed, the means adapted for allocation and virtual wiring of amplifiers is further adapted to perform the step of:
virtually wiring existing network components so that such virtual wiring can only be broken at designated points.

53. A system according to claim 36 wherein, in an iteration through all the lightpaths, the means adapted for allocation and virtual wiring of amplifiers is further adapted to perform the step of:
for each lightpath, adding a set amount to a global margin when amplifiers have been added or removed.

54. A system according to claim 53 wherein each lightpath is examined in sequence in such iteration.

55. A system according to claim 36 wherein the means adapted for allocation and virtual wiring of amplifiers is further adapted to perform the steps of:
calculating possible power ranges at every card port passed through by a particular lightpath; and
adding a drop amplifier if the following conditions are satisfied:
a55) one or more of said power ranges falls below an acceptable lower bound at any port where such lower bound is specified;
b55) a drop amplifier does not already exist in the lightpath; and
c55) an input power range at a proposed drop amplifier location is between a minimum input bound and a maximum input bound.

56. A system according to claim 55 wherein said means adapted for allocation and virtual wiring of said amplifiers is further adapted for calculating possible power ranges based on a statistical deviation method and extra global margin currently available.

57. A system according to claim 55 wherein said condition c55) is replaced by the condition:
c57) an input power range at a proposed drop amplifier location is above a maximum input bound and at least one electrical variable optical attenuator is adjusted so as to render the power range to an acceptable level.

58. A system according to claim 36 wherein the means adapted for allocation and virtual wiring of amplifiers is further adapted to perform the steps of:
calculating possible power ranges at every card port passed through by a particular lightpath; and
adding an add amplifier if the following conditions are satisfied:
a58) one or more of said power ranges falls below an acceptable lower bound at any port where such lower bound is specified;
b58) an add amplifier does not already exist in the lightpath; and
c58) the addition of an add amplifier would not saturate a receiver.

59. A system according to claim 58 further comprising means for removing any inline amplifier that is saturated.

60. A system according to claim 36 wherein the means adapted for allocation and virtual wiring of amplifiers is further adapted to perform the steps of:
calculating possible power ranges at every card port passed through by a particular lightpath;
determining a location in the lightpath where the power range was last within an inline amplifier's input bounds when at least one of said power ranges falls below an acceptable lower bound at any port where such lower bound is specified;
determining that a legitimate inline amplifier insertion point exists;
removing any amplifier downstream from said insertion point; and
adding an inline amplifier at said insertion point.

61. A system according to claim 60 wherein said means adapted for allocation and virtual wiring of amplifiers is further adapted to adjust at least one upstream electrical variable optical attenuator if a legitimate inline amplifier insertion point is not initially found, so as to create such legitimate inline amplifier insertion point.

62. A system according to claim 60 wherein said inline amplifier's input bounds include global margin.

63. A system according to claim 60 further comprising means adapted to perform the steps in claim 60 if one or more of said power ranges falls below an acceptable lower bound at any port where such lower bound is specified, and if one of the following conditions is satisfied:
an add amplifier already exists in the lightpath; or
addition of an add amplifier would saturate the receiver.

64. A system according to claim 35 wherein said report is selected from the group comprising: generated network database; shelf card inventory report; equipment list; shelf card and fiber wiring report; lightpath trace report; and simulation report.

65. A system according to claim 35 wherein said simulated optical network is a mesh network.

66. A system according to claim 35 wherein said simulated optical network comprises at least one electronic network component.

67. A computer program product comprising a computer-readable memory storing statements and instructions for use in the execution in a computer of the method of claim 1.

68. A computer data signal embodied in a carrier wave and representing sequences of instructions which, when executed by a processor, cause the processor to calculate network costs in an automated manner by performing the steps of the method of claim 1.
